(19) United States
(12) Patent Application Publication
(10) Pub. No.: US 2021/0089656 A1
(43) Pub. Date: Mar. 25, 2021

(54) REAL-TIME ADAPTIVE INTRUSION DETECTION METHODS AND APPARATUS

(71) Applicant: Raytheon Company, Waltham, MA (US)

(72) Inventors: Addison Moran, Aurora, CO (US); Luther John Durkop, III, Austin, TX (US); Ava Mistry, Aurora, CO (US); Cody Hartman, Aurora, CO (US)

(73) Assignee: Raytheon Company, Waltham, MA (US)

(21) Appl. No.: 17/007,418

(22) Filed: Aug. 31, 2020

Related U.S. Application Data
(60) Provisional application No. 62/902,626, filed on Sep. 19, 2019.

(51) Int. Cl. G06F 21/56; G06F 21/55; G06N 20/00

(52) U.S. Cl. CPC G06F 21/566; G06F 2221/034; G06N 20/00; G06F 21/552

(57) ABSTRACT

A method for monitoring a processing system in an intrusion detection system (IDS) or digital forensic system (DFS) is provided. The method includes monitoring a log file associated with the processing system and identifying a plurality of sequences within the log file. The method further includes labeling the plurality of sequences using an interface control document to create a labeled plurality of sequences. The method also includes comparing labeled plurality of sequences with a plurality of known malicious sequences of messages. Further, the method includes using a trained machine learning model to identify hacking steps within the labeled plurality of sequences and determining whether a cyber-attack on the system has occurred.

### CROSS REFERENCE TO RELATED APPLICATIONS

This application claims priority to U.S. Provisional Application No. 62/902,626, entitled “REAL-TIME ADAPTIVE INTRUSION DETECTION METHODS AND APPARATUS,” filed on Sep. 19, 2019, the entire contents of which is hereby incorporated by reference.

### TECHNICAL FIELD

The disclosure relates to cyber methods and systems, such as intrusion detection systems (IDS) and digital forensics systems for identifying and classifying attacks on embedded communication protocols.

### BACKGROUND

Communication protocols create an abundance of log files, to the extent of being un-manageable by humans. Due to their complexity, log files are often left unanalyzed and are sometimes deleted. This allows cyber-attacks to go many months before anyone finds them.

Further, communication protocols on embedded systems have little to no integrated security. Embedded protocols such as MIL-STD-1553B, CAN Bus, Modbus, and ARINC 429 are of the most common protocols used in avionics, ground vehicles, satellites, factories, and naval applications, and if exploited can result in loss of life and/or failure of mission.

These systems are typically secured by enforcing correct use of a protocol and/or by relying on states of components in the system. In these systems, a typical user manually reviews log files in order to realize cyber-attacks have occurred. Many solutions depend on variance or deviation from known and accepted activity, either from a whitelist of components or a sequence of known and accepted actions for the components. Institutions such as the Army Research Lab (ARL) and Ben-Gurion University of the Negev have also developed techniques to identify attacks. The ARL has developed the Process-Oriented Intrusion Detection Algorithm which uses function codes and hardware states to determine if there is an attack. Ben-Gurion University of the Negev has a sequence-based anomaly detection based on major frame specifications on the MIL-STD-1553B data bus. However, these techniques still does not identify the cyber-attack in advance.

### SUMMARY

The application, in various implementations, addresses deficiencies associated with identifying and classifying cyber-attacks on embedded communication protocols.

According to various aspects of the disclosure, a method for monitoring a processing system in an intrusion detection system (IDS) or digital forensic system (DFS) is provided. The method includes monitoring a log file associated with the processing system and identifying a plurality of sequences within the log file. The method further includes, labeling the plurality of sequences using an interface control document to create a labeled plurality of sequences. The method also includes comparing the labeled plurality of sequences with a plurality of known malicious sequences of messages. Further, the method includes using a trained machine learning model to identify hacking steps within the labeled plurality of sequences with respect to the plurality of known malicious sequences of messages and determining whether a cyber-attack on the IDS or DFS has occurred.

In some implementations, the method may include notifying a user of the cyber-attack on the IDS or DFS.

In some implementations, the log files may include a plurality of communication protocols. In other implementations, the log files include malicious messages.

In some implementations, the trained machine learning model may update the IDS or DFS with the plurality of known malicious sequences of messages after the cyber-attack has occurred.

In some implementations, labeling the plurality of sequences may provide context to the plurality of sequences.

In some implementations, the system may utilize an embedded communication protocol. In some implementations, the system is an airplane, a vehicle, or a factory.

In another aspect, intrusion detection system (IDS) or digital forensic system (DFS) for monitoring a processing system includes an input-output device for receiving a log file associated with the processing system and a processor for a) identifying a plurality of sequences within the log file; b) labeling the plurality of sequences using an interface control document to create a labeled plurality of sequences; c) comparing the labeled plurality of sequences with a plurality of known malicious sequences of messages; d) using a trained machine learning model to identify hacking steps within the labeled plurality of sequences with respect to the plurality of known malicious sequences of messages; and e) determining whether a cyber-attack on the IDS or DFS has occurred.

Any two or more of the features described in this specification, including in this summary section, may be combined to form implementations not specifically described in this specification.

All or part of the processes, methods, systems, and techniques described herein may be implemented as a computer program product that includes instructions that are stored on one or more non-transitory machine-readable storage media, and that are executable on one or more processing devices. Examples of non-transitory machine-readable storage media include, e.g., read-only memory, an optical disk drive, memory disk drive, random access memory, and the like. All or part of the processes, methods, systems, and techniques described herein may be implemented as an apparatus, method, or system that includes one or more processing devices and memory storing instructions that are executable by the one or more processing devices to perform the stated operations.

The details of one or more implementations are set forth in the accompanying drawings and the description below. Other features and advantages will be apparent from the description and drawings, and from the claims.

### BRIEF DESCRIPTION OF THE DRAWINGS

According to various aspects of at least one embodiment of the present disclosure are described below with reference to the accompanying figures. For simplicity and clarity of illustration, elements shown in the drawings have not necessarily been drawn accurately or to scale; the dimensions of some of the elements may be exaggerated relative to other elements for clarity, and several physical components may be included in one functional block or element. Further, where considered appropriate, reference numerals may be repeated among the drawings to indicate corresponding or analogous elements. For the purposes of clarity, not every component may be labeled in every drawing; the figures are provided for the purposes of illustration and explanation, and are not intended to define the limits of the invention.

FIG. 1 is a flow diagram of identifying a cyber-attack using the hacking process, according to certain embodiments;

FIG. 2 is a flow diagram of giving context to messages, according to certain embodiments;

FIG. 3 is a flow diagram of giving context to messages and identifying a cyber-attack, according to certain embodiments;

FIG. 4 illustrates an exemplary factory system for which a cyber-attack has happened;

FIG. 5 illustrates steps for identifying a cyber-attack, according to certain embodiments; and

FIG. 6 illustrates a system, according to certain embodiments.

### DETAILED DESCRIPTION

In the following detailed description, numerous specific details are set forth in order to provide a thorough understanding of the embodiments of the present disclosure. It will be understood by those of ordinary skill in the art that these embodiments may be practiced without some of these specific details. In other instances, well-known methods, procedures, components and structures may not have been described in detail so as not to obscure the described embodiments.

Prior to describing at least one embodiment in detail, it is to be understood that these are not limited in their application to the details of construction and the arrangement of the components set forth in the following description or illustrated in the drawings. Also, it is to be understood that the phraseology and terminology employed herein are for the purpose of description only and should not be regarded as limiting.

A computing system is an example of an electronic system that may be vulnerable to cyber-attacks. A cyber-attack may include a malware attack, for example. Malware includes malicious software that is installed on the computing system. Malware may perform various nefarious activities on the computing system. For example, the malware may expose confidential information or relay that confidential information to a remote system. In another example, ransomware, which is a type of malware, may encrypt data on the computing system and extort money from the computer's user to decrypt the data. In still another example, malware may configure the computing system to operate as part of a bot network. For example, a computing system may be configured by malware to act as a bot to mine bitcoin for a third party.

Computer systems are being used in various technologies and industries, such as ground vehicles, satellites, factories, and naval applications. Many computer systems include embedded communication protocols. Communication protocols create an abundance of log files. Cyber-attacks can be identified by analyzing log files. Currently, humans manually analyze the log files. As communication protocols create an increasing number of log files, analyzing them is becoming unmanageable. Therefore, log files are often left unanalyzed and occasionally are even deleted. As a result, cyber-attacks can go months before anyone detects them.

Currently, there are no known solutions that take log files and abstract them to add context to the messages (i.e. the actions) for improved situational awareness.

As discussed above, the computer systems which use communication protocols are typically enforced by enforcing correct use of a protocol and/or by relying on states of components in the system. That is, a typical user manually reviews log files in order to realize cyber-attacks after they occur. However, there are no known solutions that identify a cyber-attack by looking for behaviors on the system that identify steps in the hacking process (reconnaissance, scanning, gaining access, keeping access, clearing tracks).

Accordingly, the present disclosure provides a model for use in either an IDS or a digital forensics application that identifies and classifies cyber-attacks for all embedded communication protocols. That is, the present disclosure provides methods for analyzing log files to identify series of messages that show a specific action. Therefore, the method provides context to the messages by taking individual messages and grouping them into sections of logical function. In other words, the present disclosure uses machine learning to create a model that identifies and classifies cyber-attacks on embedded communications protocols for use in IDS or digital forensics applications. Then, it uses variety of interface control documents (ICDs) to learn what each message means and to train the system so it recognizes the action in the future. As a result, the disclosed methods notify the user if there is an ongoing hacking process which can result in a possible cyber-attack. For example, the approach of the disclosure exploits the hacking process to notify the user as an attack is happening.

The present disclosure can be used in any embedded system, e.g., airplanes, vehicles, and factories.

The hacking process starts when a hacker performs a preliminary survey to gain information of the system. Then, the hacker will scan that information and try to gain access to the system. After the hacker gains access to the system, the hacker will work to maintain access. As a result, the system does not operate as usual or as it is supposed to.

Log files stores the hacking messages and processes. The present disclosure analyzes log files and identifies a series of messages that shows an interesting action. It uses a variety of interface control documents (ICDs) and application programming interfaces (APIs) to learn what each message means and to train the program so it will recognize that action in the future. In other words, the system will capture messages, learn the message patterns and compare them with the hacking process to identify attacks on the system, if any. This tool can be integrated into different IDS, a digital forensics application, and log analyzers/management tools to help the user understand a cyber-attack or a system malfunction.

Some of the novel features of the present disclosure include 1) providing situational awareness by detecting potentially malicious messages using the hacking process, 2) consolidating a series of individual messages in a log file into characterized functions, 3) cross platform, being expandable to all communication protocols, 4) can be integrated into a variety of log analysis/maintenance tools, 5) can be integrated into a variety of intrusion detection systems, 6) can be integrated into a variety of digital forensics tools, 7) configurable, the system is tailorable to fit the interests of the user.

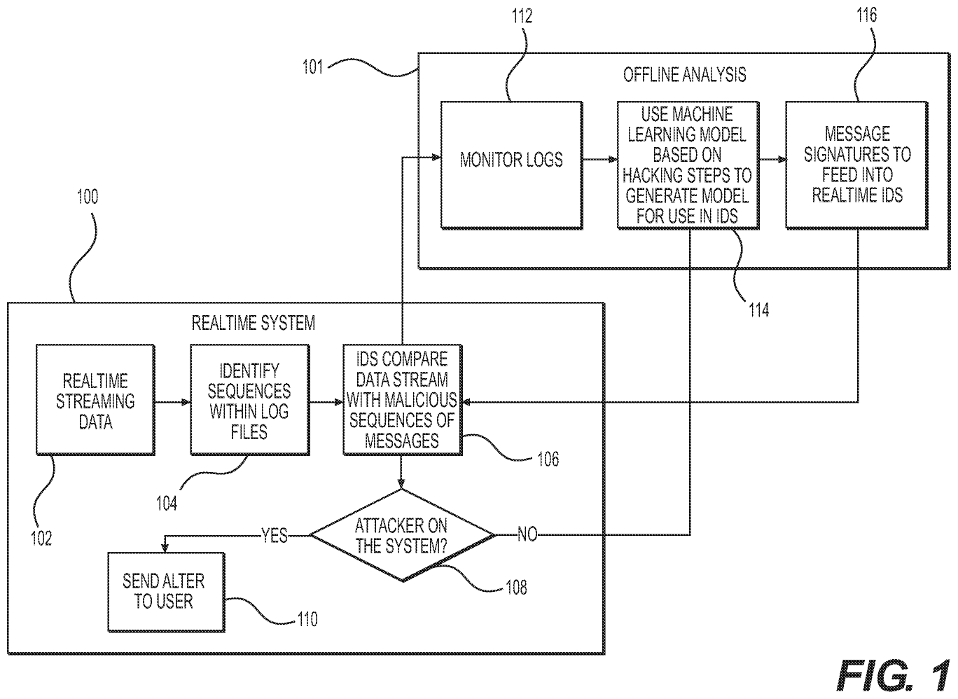

FIG. 1 is a flow diagram of identifying a cyber-attack, according to certain embodiments. The system 100 uses real-time streaming data 102 or data from a log file to identify sequences 104. Then, the system 100 compares the data with malicious sequences of messages 106. That is, the system 100 adopts offline analysis 101 which monitors data from a data bus or from log files 112 and uses a trained machine learning model based on the hacking steps to generate model 114 for use in the system 100 and then message signatures 116 to feed into the system 100. As a result, the system 100 can identify if an attack has happened 108. If an attack has taken place, the system 100 completes an action notifying the user of a possible attack 110 (action is configurable based on the use case, i.e. avionics vs factory may have different notification requirements). In cases in which this solution is deployed as an IDS and there are no attacks, the system continues to monitor log files and performs the steps of offline analysis 101 as stated above. In the case in which this solution is deployed as a digital forensics tool, the user has the ability to analyze a log file at any time.

In some embodiments, the present disclosure uses patterns in messages instead of analyzing individual messages; i.e., uses behavioral learning. Then, it recognizes a hacker's activity by realizing that an attack has changed the sequence of messages. As a result, it will predict the hacker's next steps by understanding the hacking process. Therefore, the present disclosure uses a model to train the system to expect what an attack will look like.

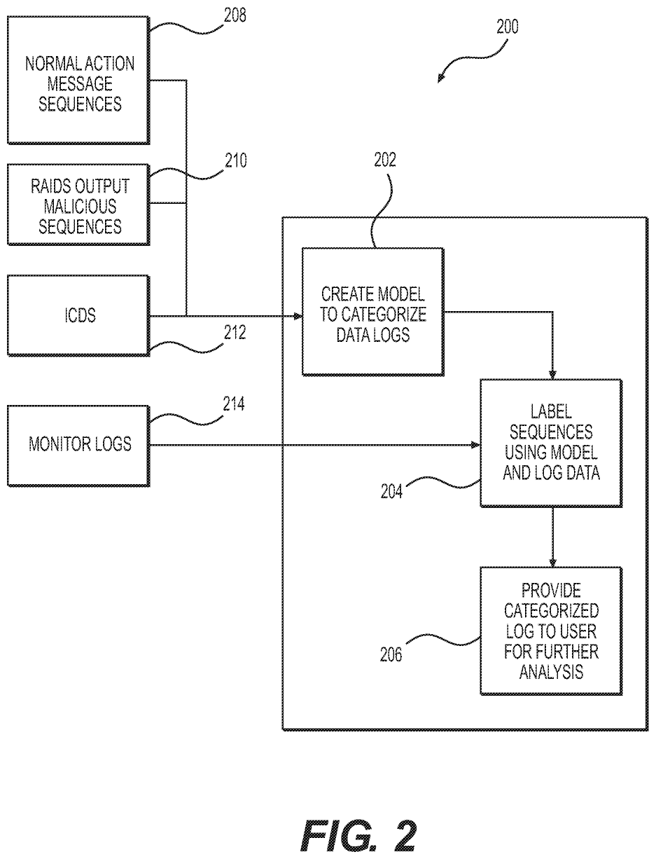

FIG. 2 is a flow diagram of giving context to messages, according to certain embodiments. As FIG. 2 illustrates, the system 200 creates a model to categorize data in log files 202 by identifying normal action message sequences 208 and malicious sequences 210 in ICDs 212. By monitoring the log files 214, the system 200 creates label sequences using the model and log file data 204. That is, the system 200 provides a label to each sequence such as malicious action messages or normal action messages. Then, it provides categorized log files to user for further analysis 206.

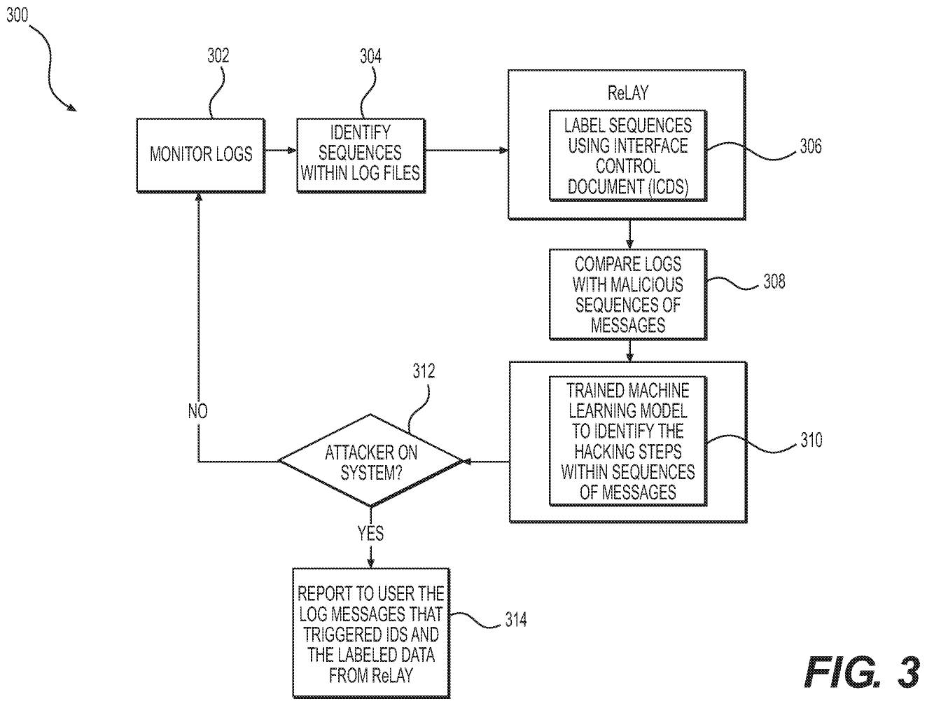

FIG. 3 is a flow diagram of giving context to messages and identifying a cyber-attack, according to certain embodiments. FIG. 3 illustrates that the system provides categorized data, gives context to messages, and identifies cyber-attacks. As FIG. 3 illustrates, the system 300 monitors log files 302 to identify and/or classify sequences within them 304. It then labels these sequences 306 using interface control documents (ICDs), giving context to the messages with the purpose of both identifying malicious sequences of messages 308 and providing context to the end user. The system 300 then uses a trained machine learning model 310 to identify and flag sequences of messages which appear to follow steps of the hacking process. If an attack has been identified 312 on the system, it will notify the user 314. In no attacks are identified, the system 300 repeats the steps above. That is, the system 300 continues to monitor log files 302 and perform steps 304 through 312.

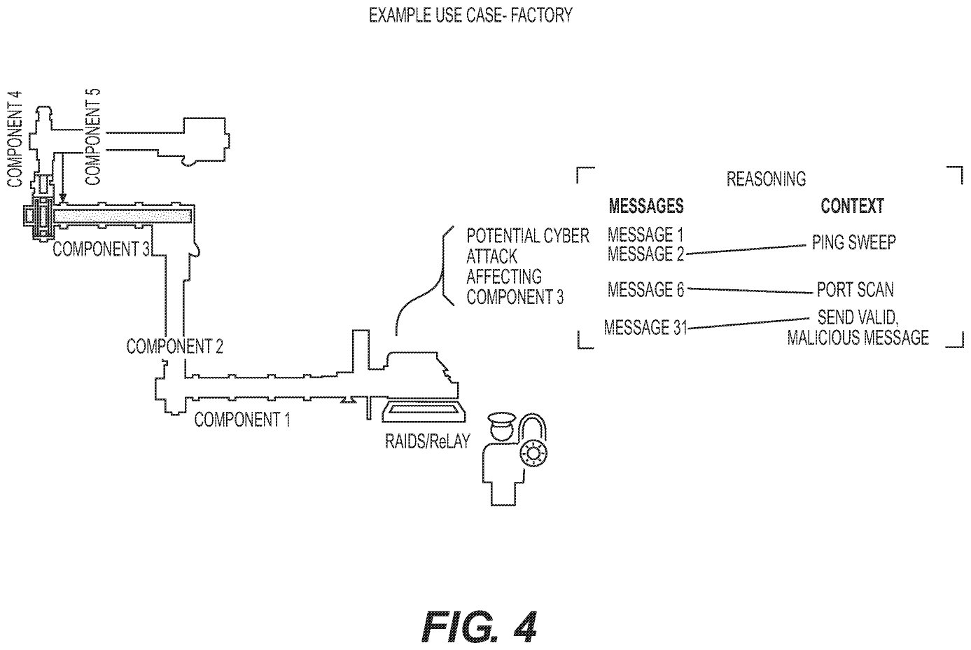

FIG. 4 illustrates an exemplary factory system for which a cyber-attack has occurred. As FIG. 4 illustrates the factory system has five various components, labeled “Component 1” through “Component 5”, and 31 messages. The technology of the present disclosure gives context to each message and uses a model to train the system when an attack might happen. Therefore, by adapting the present disclosure in the system, there can be a cyber-attack at component 3, such as receiving unusual messages.

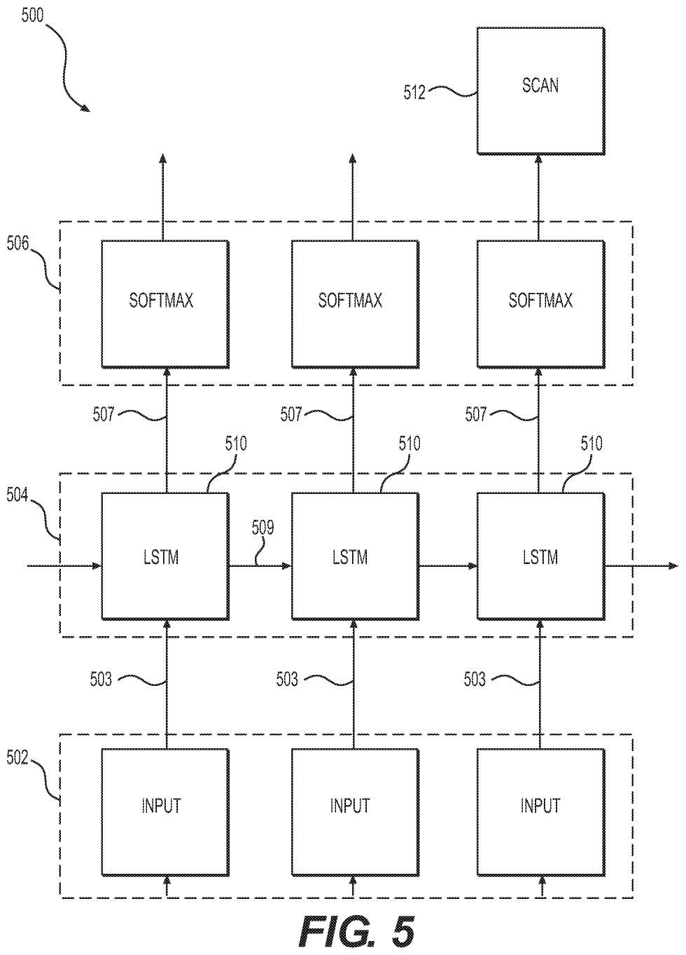

FIG. 5 illustrates steps for identifying a cyber-attack, according to certain embodiments. The system takes a log file as an input and separates the data into sequences of messages. Those messages are then separated into prominent features without reduction and fed into the input layer 502 of a Recurrent Neural Network (RNN) 500. The next layer in FIG. 5 is the Short Term Memory (LSTM) Layer 504. Messages are fed from the input layer 502 to the LSTM layer 504 represented by the flow arrows 503 in the diagram; this layer is where the RNN 500 learns patterns in a sequence. The learned weights are forwarded into a Softmax output layer 506, denoted with an arrow 507, to identify sequences of messages as part of the attack process as well as weights being sent to the next LSTM cell 510 in the layer 504. The forwarding by the LSTM cell 510 is represented by arrows 509 going from one LSTM cell 510 to another LSTM 510. After the entire sequence of input messages has been evaluated, the output from the Softmax layer 506 is the classification, represented by the scan 512. The system can also use an autoencoder to reduce feature representation and can extract features hidden within data. These extracted features are then forwarded into the same RNN LSTM Layer. These extracted features are then fed into a Support Vector Machine (SVM) to classify the message and determine if it is malicious.

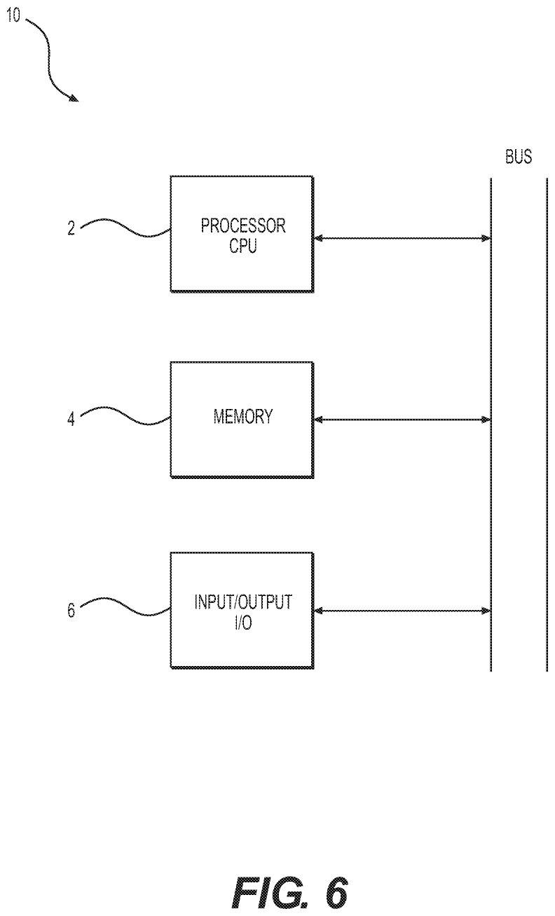

FIG. 6 illustrates a system, according to certain embodiments. The system 10 includes a memory 4 to store log files. The memory 4 can be an input-output device. The processor 2 processes each log file according to the present disclosure. The processor 2 can indicate if there is any cyber-attack happening or has happened in the system 10 and indicates the results through I/O (input/output) 6. The processor 2 can be any processor, e.g., microprocessor, or any CPU.

In some embodiments, the present disclosure can be used in forensic situations. Because the system leverages logs, it can be used with either real-time data for forensic analysis; the disclosure does not discriminate how the data was collected.

In some embodiments, the present disclosure uses known features defined in the communication protocols versus relying on certain components being on the system, e.g., transaction types, mode codes, data words (actual data transmitted), and sequences excluding probing followed by injection.

All or part of the processes described herein and their various modifications (hereinafter referred to as “the processes”) can be implemented, at least in part, using a computer program product, e.g., a computer program tangibly embodied in one or more information carriers, e.g., in one or more tangible machine-readable storage media, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected by a network.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks. Non-transitory machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

Each computing device, such as a tablet computer, may include a hard drive for storing data and computer programs, and a processing device (e.g., a microprocessor) and memory (e.g., RAM) for executing computer programs

Elements of different implementations described herein may be combined to form other implementations not specifically set forth above. Elements may be left out of the processes, computer programs, user interfaces, etc. described herein without adversely affecting their operation or the operation of the system in general. Furthermore, various separate elements may be combined into one or more individual elements to perform the functions described herein.

Various aspects of at least one implementation of the present disclosure are discussed above with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. For purposes of clarity, not every component may be labeled in every drawing. The figures are provided for the purposes of illustration and explanation and are not intended as a definition of the limits of the claims.

Other implementations not specifically described herein are also within the scope of the following claims.

What is claimed is:

1. A method of monitoring a processing system in an intrusion detection system (IDS), comprising:
monitoring a log file associated with the processing system;
identifying a plurality of sequences within the log file;
labeling the plurality of sequences using an interface control document to create a labeled plurality of sequences;
comparing the labeled plurality of sequences with a plurality of known malicious sequences of messages;
using a trained machine learning model to identify hacking steps within the labeled plurality of sequences with respect to the plurality of known malicious sequences of messages; and
determining whether a cyber-attack on the IDS has occurred.

2. The method of claim 1, further comprising notifying a user of the cyber-attack on the IDS.

3. The method of claim 1, wherein the log file comprises a plurality of communication protocols.

4. The method of claim 1, wherein the log files comprise malicious messages.

5. The method of claim 1, wherein the trained machine learning model updates the IDS with the plurality of known malicious sequences of messages after the cyber-attack has occurred.

6. The method of claim 1, wherein labeling the plurality of sequences provides context to the plurality of sequences.

7. The method of claim 1, wherein the system utilizes an embedded communication protocol.

8. The method of claim 1, wherein the system is an airplane, a vehicle, or a factory.

9. One or more non-transitory machine-readable storage media storing instructions that are executable by one or more processing devices to perform operations comprising:
monitoring a log file associated with the processing system;
identifying a plurality of sequences within the log file and labeling the plurality of sequences using an interface control document;
comparing the log file with a plurality of known malicious sequences of messages;
using a trained machine learning model to identify hacking steps within the plurality of sequences; and
determining whether a cyber-attack on an intrusion detection system (IDS) has occurred.

10. The one or more non-transitory machine-readable storage media of claim 9, wherein the trained machine learning model updates the IDS with the plurality of known malicious sequences of messages after the cyber-attack has occurred.

11. The one or more non-transitory machine-readable storage media of claim 9, wherein the log file comprises a plurality of communication protocols.

12. The one or more non-transitory machine-readable storage media of claim 9, further comprising notifying a user of the cyber-attack on the IDS.

13. The one or more non-transitory machine-readable storage media of claim 9, wherein labeling the plurality of sequences provides context to the plurality of sequences.

14. An intrusion detection system (IDS) for monitoring a processing system comprising:
an input-output device for receiving a log file associated with the processing system; and
a processor for:
a) identifying a plurality of sequences within the log file;
b) labeling the plurality of sequences using an interface control document to create a labeled plurality of sequences;
c) comparing the labeled plurality of sequences with a plurality of known malicious sequences of messages;
d) using a trained machine learning model to identify hacking steps within the labeled plurality of sequences with respect to the plurality of known malicious sequences of messages; and
e) determining whether a cyber-attack on the IDS has occurred.

15. The IDS of claim 14, wherein the trained machine learning model updates the IDS with the plurality of known malicious sequences of messages after the cyber-attack has occurred.

16. The IDS of claim 14, wherein the log file comprises a plurality of communication protocols.

17. The IDS of claim 14, further comprising notifying a user of the cyber-attack on the IDS.

18. The IDS of claim 14, wherein labeling the plurality of sequences provides context to the plurality of sequences.
